(19) United States
(12) Patent Application Publication
(10) Pub. No.: US 2002/0186304 A1
(43) Pub. Date: Dec. 12, 2002

(54) Optical image pickup device and optical range finder

(76) Inventors: Keizo Kono, Tokyo (JP); Manabu Kobayashi, Saitama-ken (JP)

Correspondence Address: NATH & ASSOCIATES, 1030 15th STREET, 6TH FLOOR, WASHINGTON, DC, 20005, US

(21) Appl. No.: 10/120,490

(22) Filed: Apr. 12, 2002

(30) Foreign Application Priority Data
Apr. 20, 2001 (JP) P2001-123631

(51) Int. Cl. H04N 5/225

(52) U.S. Cl. 348/216.1

(57) ABSTRACT

An optical image pickup device applicable to composite picture without the use of chromakey composition technique is presented. The optical image pickup device (20) includes an infrared light irradiation unit (21) for irradiating infrared light towards object, a shutter (22, 43) for modulating infrared light irradiated from the infrared light irradiation unit (21) together with infrared light reflected from the object, an image pickup lens (23) for receiving visible light and infrared light from the object, a separation prism (29) placed behind the image pickup lens (23) for separating visible light and infrared light received by the image pickup lens (23), and CCD (35a, 35b, 35c) acting as a visible light detector for receiving visible light from the separation prism (29) and detecting visible light image of the object on first image formation surface, CCD (45) acting as an infrared light detector for receiving infrared light from the separation prism (29) and detecting infrared light image of the object on second image formation surface.

### FIELD AND BACKGROUND OF INVENTION

1. Field of the Invention

The present invention relates to an optical image pickup device and an optical range finder and, particularly, to an optical image pickup device and an optical range finder for acquiring information of distance to object.

2. Description of the Related Art

Recently chromakey technique is known for preparing key from color signals in synthesizing color signals in the field of video processing. According to the chromakey technique, an object is shot with, for instance, a blue background in the back. After shooting, the blue part of the background is removed by utilizing the color difference. Then the entire picture except the object will be cut off along the contour of the object leaving only the picture of the object. Pasting the picture of object onto a different picture creates a composite picture.

Since blue is the complementary color of human skin, blue background is generally preferred in the chromakey technique or chromakey synthesizing.

In the chromakey technique, however, there is a problem in that the object cannot use dresses and the like whose color may be mixed with the background color.

### SUMMARY OF THE INVENTION

The optical image pickup device of the present invention includes an infrared light (radiation or ray) source for emitting infrared light towards object, a modulation device that modulates the infrared light emitted from the infrared light source and the infrared light reflected from the object so as to pass the infrared light for a predetermined period, an image pickup lens for receiving visible light and infrared light from the object, a visible light/infrared light separation device (prism) placed behind the image pickup lens for separating visible light and infrared light received by the image pickup lens, a visible light detector receiving the visible light from the visible light/infrared light separation device and detecting the visible light image of the object on first image formation surface, and an infrared light detector for receiving the infrared light from the visible light/infrared light separation device and detecting the infrared light image of the object on second image formation surface.

Desirably, the infrared light image detector includes a focus adjustment mechanism that adjusts focus on the second image formation surface.

Desirably, the focus adjustment mechanism includes a pair of wedge shaped glass comprising an incident and exit plane arranged perpendicular to optical axis.

Desirably, the optical image pickup device further includes an optical element for setting the optical path length from incidence surface of the visible light/infrared light separation device to the image surface conjugate to the first image formation surface of the visible light detector and the optical path length to the second image formation surface of the infrared light detector identical.

The optical range finder includes an infrared light source for emitting infrared light towards object, a modulation device that modulates infrared light emitted from the infrared light source and infrared light reflected from the object, an image pickup lens for receiving infrared light from the object, an infrared light detector for detecting infrared light image reflected from the object, and received by the image pickup lens on image formation surface, and a focus adjustment mechanism that adjusts focus on the image formation surface.

Desirably, the modulation device includes the first modulation device for modulates the infrared light emitted from the infrared light source and the second modulation device that modulates the infrared light reflected from the object.

Desirably, the modulation by the modulation device includes changing the intensity of light. More desirably, the modulation includes generating a train of optical pulse by switching light.

Desirably, the modulation device includes a shutter.

Desirably, the image pickup lens includes zoom lens.

Desirably, the optical range finder further includes a visible light/infrared light separation device (prism) placed behind the image pickup lens for separating visible light and infrared light received by the image pickup lens, and a visible light detector receiving the visible light from the visible light/infrared light separation device and detecting the visible light image of the object on image formation surface wherein the infrared light detector receives the infrared light from the visible light/infrared light separation device.

Desirably, the visible light/infrared light separation device and visible light detector include optical elements with identical optical length.

Desirably, the visible light/infrared light separation device includes a plurality of single devices.

Desirably, the focus adjustment mechanism includes optically transparent bodies with mutually parallel planes.

In order to change the distance between the parallel planes, desirably, the focus adjustment mechanism includes a pair of wedge shaped optically transparent bodies moved freely against each other.

Desirably, the optical image pickup device includes an optical path adjustment mechanism that adjusts the optical path length.

Desirably, the visible light and infrared light image formation surface is directed mutually perpendicular to each other. The nature, principle and utility of the invention will become more apparent from the following detailed description when read in conjunction with the accompanying drawings.

### BRIEF DESCRIPTION OF FIGURES

FIG. 1 shows the outline of an example of an optical range finder.

FIG. 2 illustrates a principle of range measurement of the optical range finder of FIG. 1.

FIG. 3 shows the first embodiment of the optical image pickup device of the present invention.

FIG. 4 shows the second embodiment of the optical image pickup device of the present invention.

FIG. 5 shows the third embodiment of the optical image pickup device of the present invention.

FIG. 6 illustrates the focus adjustment mechanism provided in the third embodiment of the present invention.

FIG. 7 shows how the image formation position deviates by the variation of the focal distance of the zoom lens.

### DETAILED DESCRIPTION OF EMBODIMENTS

Various embodiments of the present invention will be described with reference to the accompanying drawings.

In the present embodiment, distance information from an optical image pickup device such as a camera to an object is obtained by use of the technique described in W097/01112.

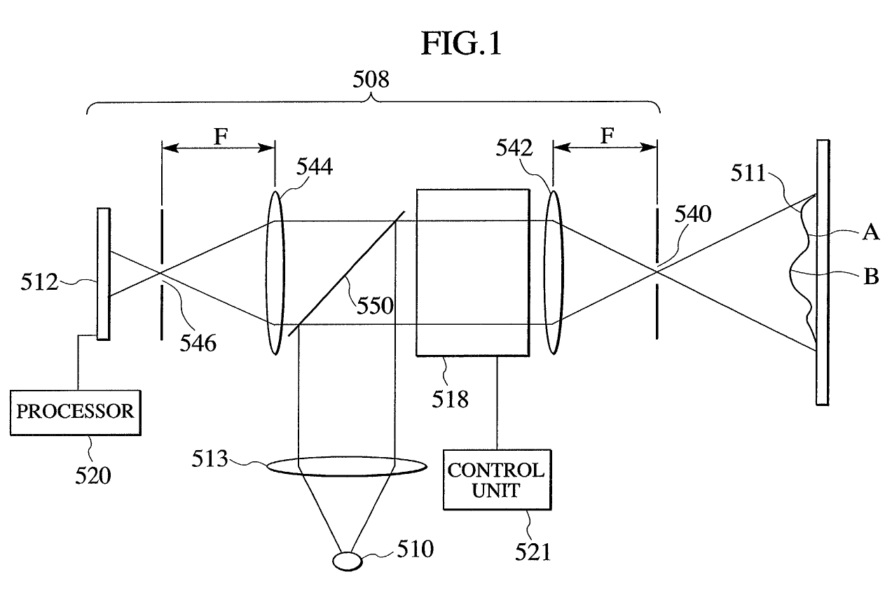

FIG. 1 is a block diagram showing the technique for obtaining distance information to an object described in W097/01112.

As shown in FIG. 1, in order to obtain distance information to an object 511, an optical range finder camera 508 used in this technique includes a laser light source 510 for emitting laser light, a first lens 513, a half mirror 550, a shutter 518 for modulation, a second lens 542, a first pupil 540, a third lens 544, a second pupil 546, CCD 512 acting as an image detector, a control unit 521 for controlling the shutter 518, and a processor 520 for processing image signal from the CCD 512.

The shutter 518 is opened only for a predetermined period comparable to the period light goes to and from between the camera 508 and the object 511. The period the shutter 518 is opened may be varied according to the distance to the object 511 to be detected from the camera 508. In this way, on the CCD 512, the light strength of the image of the object 511 at part B near the camera 508 will be stronger than the light strength of the image of the object 511 at part A further away from the camera 508. Therefore distance between the camera 508 and part B or part A may be measured by detecting the light strength of each image on the CCD 512.

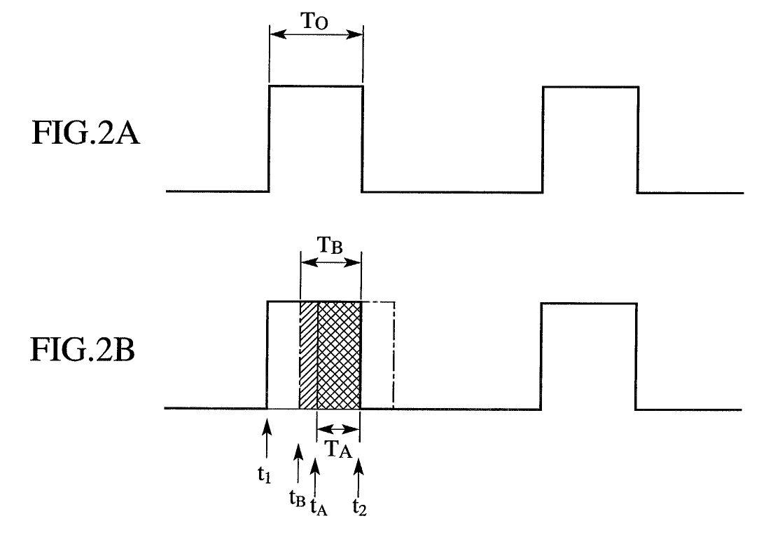

FIG. 2 is a time chart describing a principle of the distant measurement.

FIG. 2A shows the timing of the opening and closing the shutter 518 and the laser light strength variation of the laser light emitted forward to the shutter 518. The abscissa axis shows the evolution of time and the ordinate shows the opening and closing of the shutter 518 or the light strength of the laser light. As mentioned above, the time T₀ the shutter 518 is opened is set comparable to the time light goes to and from between the camera 508 and the object 511. The open time of the shutter 518 also may be varied according to the distance between the object 511 to be detected and the camera 508.

FIG. 2B shows the time t_{B} when the reflected light from a part B of the object 511 first passes the shutter 518 and the time to when the reflected light from a part A of the object 511 first passes the shutter 518. Here, t₁ and t₂ shows the timing of the opening and the closing of the shutter 518. As shown in FIG. 2B, the reflected light from the part B may return to the shutter 511 at the time t_{B} earlier than the time t_{A} the reflected light from the part A return to the shutter 511. Thus, as shown in FIG. 2B, the period T_{B (=t}₂−t_{B}) the reflected light from the part B passes through the shutter 511 until the shutter 511 is closed at the time t₂ is longer then the period T_{A}(=t₂−t_{A}) the reflected light from the part A passes through the shutter 511 until the shutter 511 is closed.

In CCD 512, the light intensity proportional to the area of the slant line part of FIG. 2B corresponding to T_{B} and the area of the crossed slant line part corresponding to T_{A} will be received by the CCD pixel for forming the pictures of part B and part A. Therefore the distance from the camera 508 to part B and part A may also be obtained by measuring the signal from the CCD pixel corresponding to each part.

1. First Embodiment

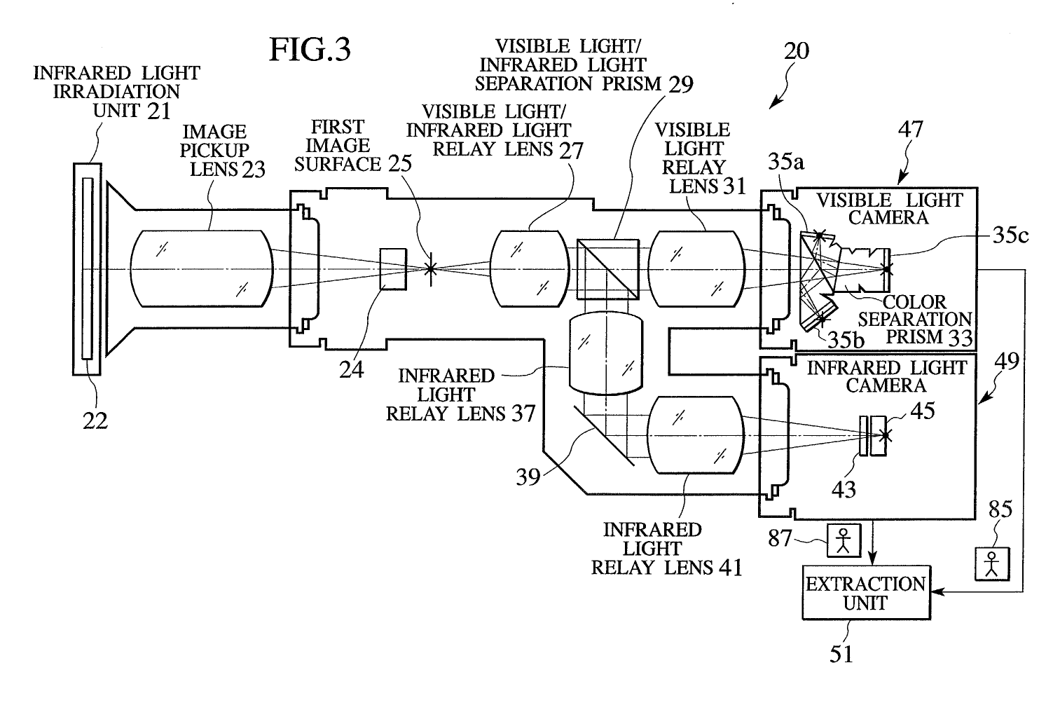

FIG. 3 shows the first embodiment of the optical image pickup device of the present invention using the range finder.

The optical image pickup device may cut out or extract a desired object from a color picture to create a composite picture without the use of the chromakey technique.

The optical image pickup device 20 (FIG. 3) of this embodiment includes an infrared light irradiation unit 21 acting as the infrared light source for irradiating infrared light to an object (not shown), shutters 22, 43 for modulating the infrared light emitted from the infrared light irradiation unit 21 together with the infrared light reflected from the object, an image pickup lens 23 for receiving the visible light and infrared light from the object, a visible light/infrared light separation prism 29 for separating visible light and infrared light received by the image pickup lens 23, a CCD 35a, 35b, 35c acting as visible light detectors for receiving visible light from the prism 29 and detecting visible light image of the object on the first image formation surface, and a CCD 45 acting as infrared light detector for detecting infrared light image of the object on the second image formation surface. The shutter 43 could be placed on any position along the optical path of infrared light and could be the same as the shutter 22.

More precisely, as shown in FIG. 3, the optical image pickup device 20 includes an image pickup lens 23 for receiving the reflected light from the object, a visible light/infrared light relay lens 27 for receiving converging light from the image pickup lens 23 via an optically transparent body 24 acting as an optical path length control device and a first image surface 25, a visible light/infrared light separation prism 29 for separating the light from the relay lens 27 into visible light and infrared light, a visible light relay lens 31 for focusing the visible light separated by the prism 29, and a visible light camera 47 for receiving the converging light from the relay lens 31 and forming the visible light image of the object.

The visible light camera 47 has a color separation prism 33 for separating the converging light from the relay lens 31 into red, blue, and green colored lights and the CCDs 35a, 35b, 35c acting as the visible light detectors arranged at the projection surfaces of each color of the color separation prism 33. The image pickup lens 23 also includes zoom lens.

Therefore by the arrangement, a color picture signal 85 of the object may be generated from the visible light camera 47.

As shown in FIG. 3, the optical image pickup device 20 also includes an infrared light irradiation unit 21 for irradiating infrared light laser light to the object (not shown). This unit 21 has a shutter 22 inside acting as a first modulation device to modulate the infrared light emitted from the infrared light irradiation unit 21. The optical image pickup device 20 also includes a first infrared relay lens 37 for transmitting infrared light separated from the visible light/infrared light separation prism 29, a reflection mirror 39 for changing the direction of the infrared light to the direction parallel to the direction of the light incident to the image pickup lens 23 from the relay lens 37, a second infrared light relay lens 41 for converging infrared light from the reflection mirror 39, and an infrared light camera 49 for focusing the converged infrared light and forming an infrared light image of the object.

The infrared light camera 49 has a shutter 43 acting as the second modulation device for modulating the focused light from the relay lens 41 and a CCD 45 acting as the infrared light detector arranged at the second image formation surface of the focused light.

Also the dummy glass 24 for controlling optical path length may improve the focusing performance on the first image formation surface of CCD 35a, 35b, 35c and on the second image formation surface of the CCD 45.

Now the time T₀ the shutter 22 acting as the first modulation device and the shutter 43 acting as the second modulation device is left open (refer FIG. 2) is set comparable to the time the infrared light goes to and returns from the object to be discriminated or detected.

By the same arrangement similar to the optical range finder camera explained by reference to FIGS. 1 and 2, the infrared light image of the object is formed on the image formation surface of the CCD 45 acting as an infrared light detector. The infrared light image from a nearby object has a strong light intensity and the image from a distant object has a weak light intensity.

Therefore by the arrangement, a color picture signal 85 of the object may be generated from the visible light camera 47.

As shown in FIG. 3, the optical image pickup device 20 of this embodiment also has a specified object color picture extraction unit 51 for extracting or cutting out a color picture of a specified object based on the color picture signal 85 from the visible light camera 47 and the infrared light picture signal 87 from the infrared light camera 49.In more detail, this extraction unit 51 obtains data on the outlines or profiles of the specified object based on the distance information from the infrared light picture signal 87.The picture of the specified object positioned nearby the optical image pickup device 20 is formed with high strength and the background image is formed with low strength. Therefore, for instance, by detecting the outlines of the infrared light image formed with high strength, the outline (data or information) of the specified object near the optical image pickup device may be obtained.

Next the specified object color picture extraction unit 51 acting as the specified object color picture extraction device will, based on the outline data, extract or cut out the color picture of the specified object from the color picture signal 85.

Using the arrangement, the optical image pickup device 20, for instance, allows a color picture of a specified object to be cut out from the color picture signal 85 to prepare a composite picture.

2. Second Embodiment

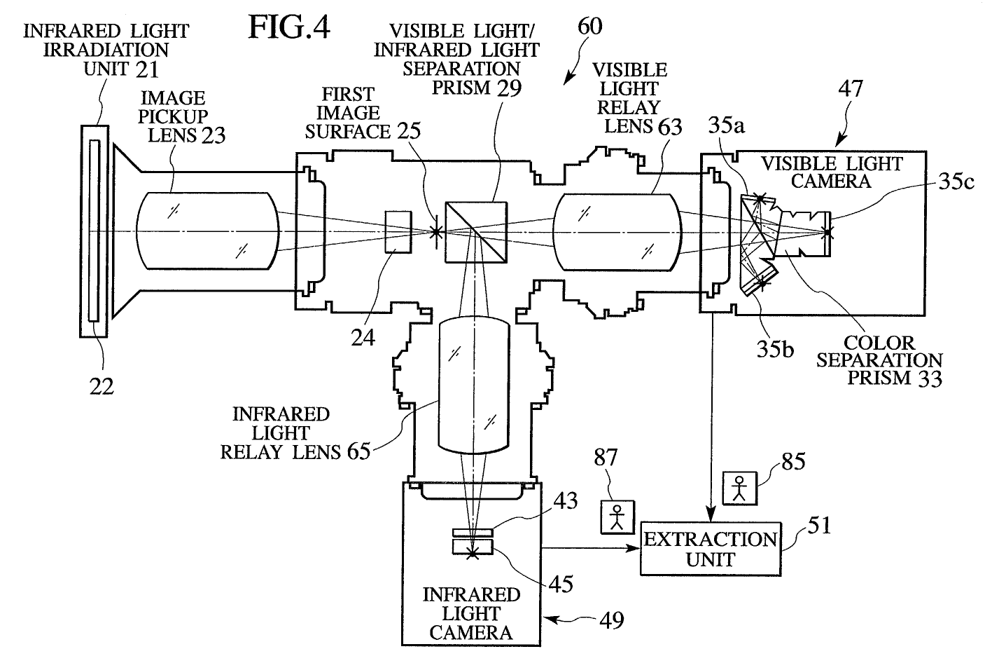

FIG. 4 shows the second embodiment of the optical image pickup device of the present invention.

The difference between the second embodiment and the first embodiment is that the visible light/infrared light relay lens 27 (FIG. 3) in the first embodiment is omitted and that the two infrared light relay lens 37, 41 (FIG. 3) are put together as a single relay lens 65 (FIG. 4). Therefore reducing the number of parts may reduce cost.

3. Third Embodiment

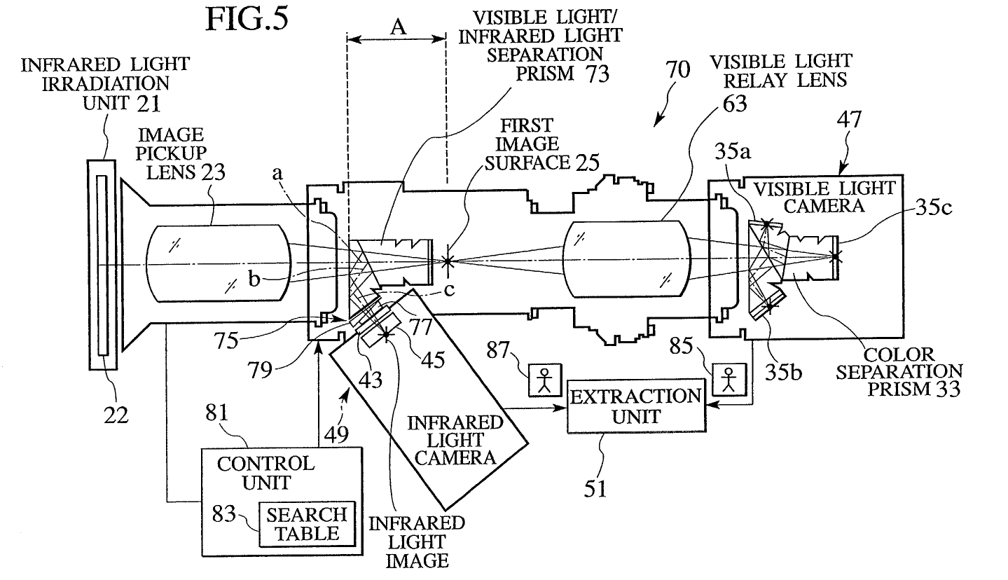

FIG. 5 shows the third embodiment of the optical image pickup device of the present invention.

The difference between the third embodiment and the second embodiment is provision of a visible light/infrared light separation prism 73 (FIG. 5) between the image pickup lens 23 and the infrared light camera 49 and provision of a focus adjustment mechanism 75 for adjusting focus between the CCD 45 acting as the infrared light detector and the separation prism 73.

By providing the visible light/infrared light separation prism 73, the infrared light relay lens 65 (FIG. 4) may be omitted and both visible light and infrared light may realize good focusing performance. Also the optical path length of the optical path “A” from the incident plane of the visible light/infrared light separation prism 73 to the image surface (the first image surface) 25 conjugate to the first image formation surface of the CCD 30a, 30b, 35c and the optical path “a+b+c” from the incident plane of the visible light/infrared light separation prism 73 to the CCD 45 is the same (i.e. A=a+b+c). Thus accurate range measurements may be made since the aberration of infrared light and visible light may be corrected equally. Here the optical path “a” leads the infrared light from the incident plane of the separation prism 73 to the first reflection plane of the prism 73, the optical path “b” leads the infrared light from the first reflection plane to the second reflection plane (which is coincidental with the incident plane of the separation prism 73) and the optical path “c” leads the infrared light from the second reflection plane to the second image formation surface of the CCD 45.

Also by placing the focus adjustment mechanism 75 in front of the CCD 45 acting as the infrared light detector, adjustment of the infrared light image formed on the infrared light image formation surface of the CCD 45 may be optimized.

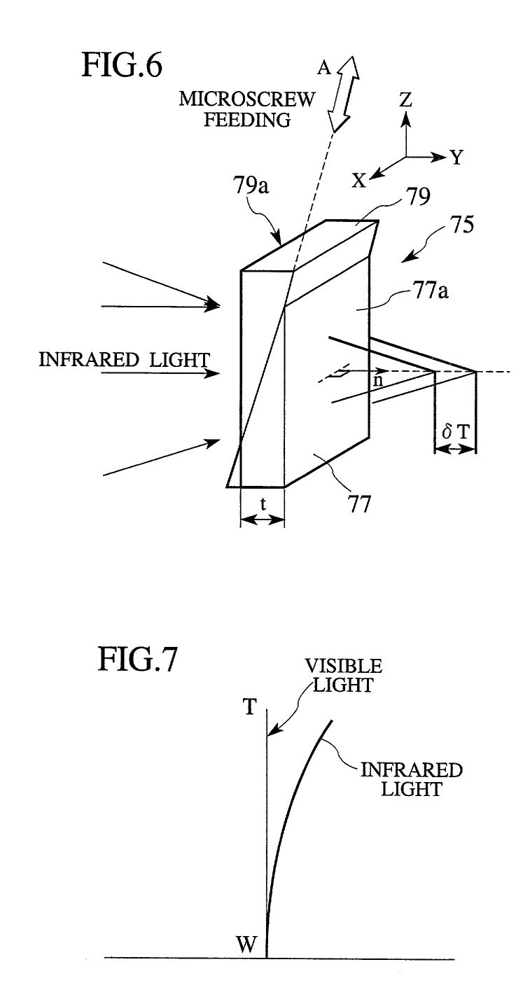

FIG. 6 shows an enlarged figure of the focus adjustment mechanism 75.

As shown in FIG. 6, the focus adjustment mechanism 75 has a first wedge shaped glass (first wedge shaped optically transparent body) 77 having an exit plane 77a that opposes the infrared light camera 49 and is orthogonal to the optical axis “n” of the camera 49. The mechanism 75 also has a second wedge shaped glass 79 having an incident plane 79a arranged parallel to the exit plane 77a. The second wedge shaped glass 79 is arranged to move freely along the wedge contact plane (which in parallel to axis A in FIG. 6) in order to change the spacing t between the exit plane 77a and the incident plane 79a. The cross section shape of the first wedge shaped glass 77 and the second wedge shaped glass 79 is triangular in FIG. 6 but it is not limited to this shape. For instance the cross section shape of at least either the first wedge shaped glass 77 or the second wedge shaped glass 79 may be trapezoidal. In short it may be of any form as long as the spacing t between the exit plane 77a and the incident plane 79a may be varied by moving the first wedge shaped glass 77 and the second wedge shaped glass 79 against each other.

In order to move the second wedge shaped glass 79 against the first edge shaped glass 77 along the axis A, a microscrew (not shown in the figure) is coupled to the second wedge shaped glass 79.

Therefore by driving the microscrew by a driving device such as an adequate electric motor, the spacing t between the incident plane 79a and the exit plane 77a may be changed and adjusted by moving the second wedge shaped glass 79 against the first wedge shaped glass 77 along the axis A.

When the spacing t changes by δt, the focal point of the infrared light will change by,

δT=δt(1−1/N),

wherein N is the refractive index of the first and second wedge shaped glass (the first and second wedge shaped optically transparent body) 77, 79.

By the composition, the focal point of the infrared light may be held accurately on the image formation surface of the CCD 45 acting as the infrared light detector.

Specifically, zoom lens generally maintains good performance in the visible light region and maintains the focal position at a constant image surface position when the focal distance is changed. However the infrared light region is outside its usable region and the focal position at fixed image surface position in the wide range positions may deviate from the surface position in the telescope range positions.

FIG. 7 shows how the image formation position of the infrared light deviates by variation of the focal distance of the zoom lens. Symbols “W” and “T” on the ordinate representing the focal distance denote “wide ” and “telescope”, respectively.

Table 1 shows the deviation of the focal position for infrared light with infrared light wavelengths 790 nm, 800 nm, 810 nm when the focal distance of the zoom lens changes by 7.8, 16, 31, 62, 94, 133 (mm).

TABLE 1
Focal Position of Infrared Light
in General Zoom Lens (mm) G-ch Standard

| Focal Distance | Wave Length (nm) | | |
|---|---|---|---|
| (mm) | 790 | 800 | 810 |
| 7.8 | 0.084 | 0.091 | 0.099 |
| 16 | 0.081 | 0.088 | 0.096 |
| 31 | 0.090 | 0.099 | 0.107 |
| 62 | 0.153 | 0.164 | 0.175 |
| 94 | 0.228 | 0.242 | 0.257 |
| 133 | 0.468 | 0.485 | 0.503 |

Therefore when general zoom lens are used, good image formation performance may be obtained in the visible light region but since the pictures out of focus will be taken in the infrared light region, the accuracy of distance measurements between the optical image pickup device and the object will deteriorate.

By reference again to FIG. 5, the third embodiment has a control unit 81 for controlling the driving mechanism (not shown in the figure) for driving the microscrew coupled to the second wedge shaped glass 79 in order to compensate the image formation position (focus position) of the infrared light due to variation of the focal distance of the zoom lens. The control unit 81 has a search table 83 corresponding to Table 1. The control unit 81 controls the microscrew driving mechanism based on the focal distance information from the zoom lens acting as the image pickup lens 23 while referring to the search table 83.

Therefore by this embodiment, the deviation of the focal position of the infrared light due to variation of the focal distance of the zoom lens is compensated and the infrared light image will always be focused on the image formation surface of the infrared light detector 45 and the distance between the optical image pickup device 70 and the object may be measured accurately.

As explained, by the optical image pickup device of the present invention, the desired object may be extracted or cut out from the color picture without use of the chromakey technique. It should be understood that many modifications and adaptations of the invention will become apparent to those skilled in the art and it is intended to encompass such obvious modifications and changes in the scope of the claims appended hereto.

What is claimed is:

1. An optical image pickup device comprising:
an infrared light source for emitting infrared light towards object;
a modulation device that modulates infrared light reflected from the object so as to pass the infrared light for a predetermined period;
an image pickup lens for receiving visible light and infrared light from the object;
a visible light/infrared light separation device placed behind the image pickup lens for separating visible light and infrared light received by the image pickup lens;
a visible light image detector for receiving visible light from the visible light/infrared light separation device and detecting visible image of the object on first image formation surface; and
an infrared light image detector for receiving infrared light from the visible light/infrared light separation device and detecting infrared light image of the object on second image formation surface.

2. The optical image pickup device of claim 1, wherein
the infrared light image detector includes a focus adjustment mechanism that adjusts focus on the second image formation surface.

3. The optical image pickup device of claim 2, wherein
the focus adjustment mechanism includes a pair of wedge shaped glass comprising an incident and exit plane arranged perpendicular to optical axis.

4. The optical image pickup device of claim 1, further comprising:
an optical element for setting the optical path length from incident plane of the visible light/infrared light separation device to the image surface conjugate to the first image formation surface of the visible light detector and the optical path length to the second image formation surface of the infrared light image detector identical.

5. An optical range finder comprising:
an infrared light source for emitting infrared light towards object;
a modulation device that modulates infrared light emitted from the infrared light source and infrared light reflected from the object;
an image pickup lens for receiving infrared light from the object;
an infrared light detector for detecting infrared light image reflected from the object, and received by the image pickup lens on image formation surface; and
a focus adjustment mechanism that adjusts focus on the image formation surface.
